(19) United States
(12) Patent Application Publication
(10) Pub. No.: US 2026/0277239 A1
(43) Pub. Date: Sep. 17, 2026

(54) METHODS AND APPARATUS FOR NAVIGATION BASED ON TRACKING ORIENTATIONS

(71) Applicant: Insitu, Inc., A Subsidiary of the Boeing Company, Bingen, WA (US)

(72) Inventors: Rolf Theodoor Rysdyk, Hood River, OR (US); Scott Patrick Marmillion, White Salmon, WA (US); David Matthew Ingraham, White Salmon, WA (US)

(21) Appl. No.: 19/077,904

(22) Filed: Mar. 12, 2025

(51) Int. Cl. G05D 1/654; G05D 1/24; G05D 1/606; G05D 1/686; G05D 1/689; G05D 109/20; G05D 111/10; G05D 111/50

(52) U.S. Cl. CPC G05D 1/6542; G05D 1/24; G05D 1/606; G05D 1/686; G05D 1/689; G05D 2109/20; G05D 2111/10; G05D 2111/52; G05D 2111/56

(57) ABSTRACT

Methods and apparatus for navigation based on tracking orientations are disclosed. An example apparatus includes interface circuitry communicatively coupled to an aiming device and an image sensor carried by an aircraft, machine-readable instructions, and at least one processor circuit to be programmed by the machine-readable instructions to determine orientations of the aiming device as the image sensor tracks a target via the aiming device, determine navigation information of the aircraft based on the orientations and flight sensor data corresponding to the tracking of the target with the image sensor, and guide movement of the aircraft based on the navigation information.

### FIELD OF THE DISCLOSURE

This disclosure relates generally to navigation and, more particularly, to methods and apparatus for navigation based on tracking orientation.

### BACKGROUND

Typically, aircraft rely on global navigation satellite system (GNSS) signals, such as global positioning system (GPS) signals, for navigation. However, the GNSS signals may not be available or can be jammed. For camera-based control, some known implementations utilize bearings-only localization, visual-based servo control, and positioned-based visual servo controls.

In a known application for navigation of an aircraft in the absence of GNSS signals, vision-based guidance is utilized for a fixed-wing aircraft in orbit relative to a target. In particular, an imagery-derived relative-bearing based control method is utilized for the aircraft in orbit about the target. In turn, the image-based guidance is combined with a two-dimensional (2D) estimator for a planar position and wind.

### SUMMARY

An example apparatus includes interface circuitry communicatively coupled to an aiming device and an image sensor carried by an aircraft, machine-readable instructions, and at least one processor circuit to be programmed by the machine-readable instructions to determine orientations of the aiming device as the image sensor tracks a target via the aiming device, determine navigation information of the aircraft based on the orientations and flight sensor data corresponding to the tracking of the target with the image sensor, and guide movement of the aircraft based on the navigation information.

An example non-transitory machine-readable medium includes machine-readable instructions to cause at least one processor circuit to at least determine orientations of an aiming device that orients an image sensor toward a target to track the target as an aircraft carrying the aiming device moves, and determine navigation information of the aircraft based on the orientations and flight sensor data corresponding to the tracking of the target with the image sensor.

An example method includes determining, by at least one processor circuit programmed by at least one instruction, orientations of an aiming device that causes an image sensor to track a target as an aircraft carrying the aiming device moves relative to the target, determining, by one or more of the at least one processor circuit, navigation information of the aircraft based on the orientations and flight sensor data corresponding to the tracking of the target with the image sensor, and directing, by one or more of the at least one processor circuit, movement of the aircraft based on the navigation information.

### BRIEF DESCRIPTION OF THE DRAWINGS

FIG. 1 illustrates an example aircraft in which examples disclosed herein can be implemented.

FIG. 2 is an example process flow in accordance with teachings of this disclosure.

FIG. 3 illustrates example results that can be obtained with examples disclosed herein.

FIG. 4 illustrates aspects of a formal observability condition with respect to examples disclosed herein.

FIG. 5 illustrates an example notional aspect of an estimation problem.

FIGS. 6A-6C illustrate example aspects of scaling that can be implemented in examples disclosed herein.

FIGS. 7-9B illustrate example utilization of a payload estimator that can be implemented in examples disclosed herein.

FIGS. 10 and 11 illustrate a comparison with results in known implementations.

FIG. 12 is a block diagram of an example payload orientation analysis system that can be implemented in examples disclosed herein.

FIG. 13 is a flowchart representative of example machine readable instructions and/or example operations that may be executed, instantiated, and/or performed by example programmable circuitry to implement the payload orientation analysis system of FIG. 12.

FIG. 14 is a block diagram of an example processing platform including programmable circuitry structured to execute, instantiate, and/or perform the example machine readable instructions and/or perform the example operations of FIG. 13 to implement the payload orientation analysis system of FIG. 12.

FIG. 15 is a block diagram of an example implementation of the programmable circuitry of FIG. 14.

FIG. 16 is a block diagram of another example implementation of the programmable circuitry of FIG. 14.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Methods and apparatus for navigation based on tracking orientations are disclosed. Navigation in the absence of global navigation satellite system (GNSS) signals, such as global positioning system (GPS) signals, can necessitate utilization of other sensor systems for navigation. In particular, some known implementations utilize a vision-based guidance for a planar position with a two-dimensional (2D) estimator. However, such implementations are constrained in two dimensions and must be carefully tuned and initialized to ensure requisite consistency.

In accordance with examples disclosed herein, turret-based navigation and guidance has been demonstrated as feasible for a routine mission task. In particular, an orientation of a turret (e.g., a payload orientation) relative to an aircraft, unmanned aircraft system (UAS) or aerial vehicle (AV) carrying the turret is defined with two angles, which may be used to guide the aircraft towards a target when the payload is image-stabilized on that target. Image-stabilization typically includes a combination of inertial sensors and image processing. Accordingly, gyroscopes can provide rate information that is compensated for by electronic gimbals, and disturbances in a camera field-of-view can be corrected in substantially real-time with common image-processing techniques. Significantly, according to examples disclosed herein, the aforementioned payload angles can be combined with a vehicle orientation in an estimator that can provide both navigation information, as well as wind estimates. As a result, based on the available navigation and wind estimates, conventional guidance laws may be utilized to stabilize the aircraft along a defined and/or desired path. Furthermore, when an image is temporarily obscured or occluded, kinematics may be utilized to provide a dead-reckoning estimate of vehicle navigation, a payload orientation, and screen coordinates of the target.

Examples disclosed herein can be utilized for stabilized ship observation from a fixed-wing aircraft without necessitating GNSS signals. Accordingly, it can be assumed that the aircraft altitude and air speed are regulated using a common air data system and that the payload is independently stabilized on the ship. Both assumptions are based on common intelligence, surveillance, and reconnaissance (ISR) mission practices.

Examples disclosed herein demonstrate that the aircraft can be guided to stabilized motion using payload orientation only. Furthermore, if the ship location is known a priori and aircraft heading information is available, a location of the aircraft and wind conditions can be estimated. Wind can be significant in the operation of relatively small aircraft and/or and, according to examples disclosed herein, an estimate of the wind is utilized to position the aircraft relative to the ship and improve path following. The methods of examples disclosed herein enable an operator to guide the aircraft using established user interfaces, or via payload imagery alone, for example. Aircraft, AVs and/or UAS that carry gimballed payloads can benefit from the presented method of examples disclosed herein. Advantageously, payload gimbal angle signals are commonly available onboard as part of imagery meta-data in known systems.

Examples disclosed herein implement a three dimensional bearing-only methodology, such that an additional degree of freedom can add significant robustness. By taking advantage of a look-down angle in addition to flight information (e.g., flight sensor information, flight data, etc.), relative bearing, a relatively simple controller and altimetry can be implemented with an estimator. Accordingly, a significant relaxation of a persistent excitation (PE) requirement can result and, in turn, the aforementioned estimator can operate with increased robustness over relatively long distances and, thus, can support relatively long distance endurance missions, for example.

Typically, an ISR mission task can involve approaching a remote target for observation with a payload, such as a camera/image sensor. Particularly, the ISR mission task usually includes an enroute phase to reach the general vicinity of a target. The enroute phase is then followed by a transition to orbit around the target or moving to a stand-off observation maneuver. To that end, examples disclosed herein can be utilized effectively in the absence of GNSS and/or GPS signals. Moreover, examples disclosed herein can enable a navigation estimator with increased robustness by utilizing barometric altitude information, for example.

Examples disclosed herein can utilize bearing-only navigation principles to the ship-approach task executed without necessitating GNSS and/or GPS signals. Examples disclosed herein can avoid a full maneuvering typically necessitated for PE by utilization of defined and/or specific choreography of the approach procedure to increase and/or maximize observability when approaching the ship, and robustness can be increased by utilizing barometric altitude measurements. Further, an availability of an aircraft heading can enable examples disclosed herein to determine absolute navigation when a target, such as a ship location (e.g., for a ship-based recovery), is transmitted or otherwise known.

Examples disclosed herein analyze movement (e.g., orientations) of an aiming device (e.g., a gimbal) that controls an orientation of a sensor, such as an image sensor (e.g., a camera), in conjunction with flight data (e.g., flight sensor data, flight sensor information, aiming device data, inertial data, movement data, barometric data, etc.) for navigation. Examples disclosed herein determine orientations of the aiming device as the aiming device is utilized for tracking the sensor with respect to a target. In particular, the aiming device can be directed to orient the sensor based on output therefrom. Accordingly, the orientations and the flight data can be utilized for determination of navigation information for guiding movement of the aircraft. As a result, examples disclosed herein can be utilized to navigate the aircraft in the absence of GNSS signals. Further, examples disclosed herein can enable navigation of the aircraft without necessitating emissions and/or signals to emanate therefrom, which can be highly advantageous in certain applications (e.g., ISR applications, etc.).

In some examples, wind (e.g., a wind condition, wind information, wind effects, localized wind effects, etc.) is estimated based on the orientations and the flight information. Additionally or alternatively, the navigation of the aircraft is determined at least partially based on inertial information corresponding to the tracking of the target with the aiming device. In some examples, the navigation information includes and/or corresponds to a position of the aircraft relative to the target. According to some examples disclosed herein, the aircraft is controlled to maneuver relative to the target and/or an area corresponding to the target (e.g., an area corresponding to a last known or presumed area of the target). In some such examples, the aircraft can be controlled and/or directed to maneuver in a figure-8 pattern or an orbiting pattern with respect to the target. In some examples, the navigation information is utilized to enable the aircraft to land on a moving vehicle, such as a ship at sea, for example.

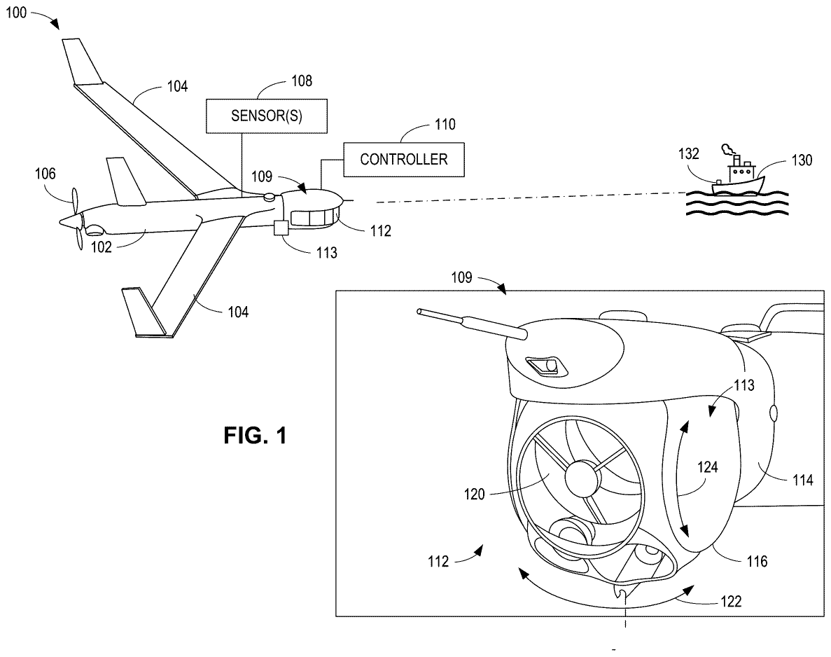

FIG. 1 illustrates an example aircraft 100 in which examples disclosed herein can be implemented. The aircraft 100 of the illustrated example is a fixed wing aircraft, and includes a fuselage 102, wings 104, a propulsion device 106, at least one flight sensor 108, a nose section 109, and a controller (e.g., a flight controller) 110. In turn, the example nose section 109 supports a payload 112, which is implemented as an image sensor (e.g., a camera) in this example and herein referred to as the image sensor 112. The example image sensor 112 can be moved and/or oriented by an aiming device (e.g., a gimbal) 113.

In the illustrated example of FIG. 1, a detailed view of the example nose section 109 is depicted. In this example, a fuselage portion 114 supports the aiming device 113 having a housing (e.g., a movable housing, a rotatable housing, etc.) 116 which, in turn, positions and/or orients the image sensor 112. Further, the example image sensor 112 includes a sensing portion (e.g., a camera lens, an image sensing portion, etc.) 120. In this example, the housing 116 can be moved, oriented and/or rotated relative to the fuselage portion 114. While an image sensor is implemented in this example, any appropriate other type of sensor can be utilized instead (e.g., an acoustic sensor, a thermal sensor, a magnetic sensor, etc.).

To track a target, such as a ship at sea for example, as the aircraft 100 is in flight, the sensing portion 120 of the image sensor 112 is oriented and/or directed via the aiming device 113. According to examples disclosed herein, the aiming device 113 can be rotated in multiple degrees of freedom, as generally indicated by arrows 122, 124 to track the target. Accordingly, the aiming device 113 can move the image sensor 112 to track the target while the aircraft 100 is moved in an orbit and/or orbiting motion relative thereto.

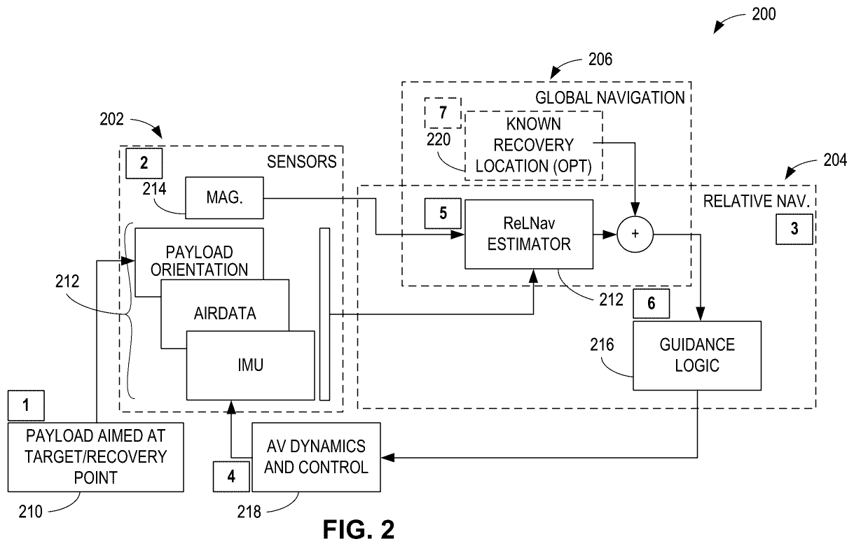

As will be discussed in greater detail below in connection with FIGS. 2-13, examples disclosed herein utilize orientations of the image device 112, the sensing portion 120 and/or the aiming device 113 corresponding to tracking of a target (e.g., a ground-based target, a ship-based target, a moving target, a ground-based vehicle target, etc.) in conjunction with flight sensor information to estimate navigation information and, in turn, guide movement of the aircraft. In other words, orientations of the image device 112 while the image device 112 tracks the target are utilized in conjunction with the flight sensor information, which may include inertial data of the aiming device 113 for example, to guide movement of the aircraft. According to some examples disclosed herein, wind information and/or conditions is/are estimated based on the orientations and the flight sensor information. Accordingly, the wind information and/or conditions can be utilized to guide the movement and/or the navigation of the aircraft 100.

In accordance with teachings of this disclosure, without necessitating GNSS/GPS signals, and utilizing passive sensors, a robust, payload-orientation based, air vehicle relative-navigator is enabled. According to some examples disclosed herein, only payload orientation, airdata, and heading are utilized, thereby enabling robust maneuvering for final approach acquisition for a shipboard recovery, for example. In some examples, if a ship location is transmitted or otherwise known, then the estimator can provide a global location, inertial velocity, and a wind estimate. According to examples disclosed herein, the estimator can be important for robust maneuvering that enables ship tracking, observation, and approach acquisition.

Examples disclosed herein enable a method that, without the utilization of GNSS signals, can enable continuous guidance of the aircraft 100 and a payload orientation thereof during approach to a moving ship 130 (e.g., a moving ship on the ocean or other body of water) for recovery aboard that ship, for example. Particularly, the aircraft 100 can be guided to land on a deck 132 of the ship 130. According to examples disclosed herein, a guaranteed robustness of an associated navigation estimator can be maintained. Examples disclosed herein can implement logic that enables approach to, and maneuvering relative to, the moving ship 130 when a passive payload is used as the primary source for locating the aircraft 100 relative to the ship 130.

In accordance with teachings of this disclosure, a navigation estimator can be implemented to robustly estimate a wind over the deck 132 of the ship 130 as an aircraft 100 approaches the ship 130, thereby enabling robust stand-off maneuvering relative to the ship 130, such as tracking and observation in orbit or a stand-off figure eight, for example. Examples disclosed herein do not necessitate PE at an altitude above the ship 130. Particularly, PE can be incompatible with most aviation protocols or ISR-missions, etc.

Examples disclosed herein can enable an ability to perform a figure eight stand-off maneuvering for a ship-board recovery procedure by accommodating the acquisition of favorable final approach conditions. Examples disclosed herein can utilize a method that includes estimation of wind over the deck 132 of the ship 130 to orient the aircraft 100 for appropriate motion relative to the ship 130. Examples disclosed herein can robustly estimate the wind over the deck in the absence of GNSS signals.

FIG. 2 is an example process flow 200 in accordance with teachings of this disclosure. The example process flow 200 can correspond to a closed loop system where the aircraft 100 is visually tracking a target, such as a moving ship (e.g., the ship 130 of FIG. 1), for example. According to examples disclosed herein, removing inherent GNSS/GPS reliance from micro-electromechanical systems (MEMS) based navigation systems can be challenging. According to some examples disclosed herein, the process flow 200 can be utilized to bring the aircraft 100 within range of the moving ship such that another system and/or methodology can be employed to enable the aircraft 100 to be recovered by the moving ship.

According to examples disclosed herein, the following operations can be utilized: (1) autopilot logic capable of “keeping the sunny side up” independent of GNSS/GPS signal quality or integrity and with robustness to erroneous heading initialization, (2) recovery without GNSS, GPS and/or RTK (relative positioning using differential GPS principles) signals, and (3) performing a method for mission tasking independent of and/or without GNSS signals. Examples disclosed herein can focus on enabling a common ISR mission scenario, in which a remote ship is approached and circled for observation. Examples disclosed herein enable a robust navigation and guidance method that can be implemented within the existing avionics framework and, thus, can enable an ISR mission task when GNSS signals are not available (e.g., the GNSS signals are jammed, etc.). Examples disclosed herein implement a controller that, given only information and/or cues available onboard, guides the aircraft to approach and maintain orbit about a ship. Accordingly, in some examples, it is assumed that a ship can be identified and tracked with an onboard imaging system.

In the illustrated example of FIG. 2, an example block 202 corresponds to flight sensor analysis, an example block 204 corresponds to navigation estimation and, in some examples, an example block 206 corresponds to global navigation. Further, an example block 210 corresponds to the aiming device 113 of FIG. 1 being oriented and/or aimed toward a target and/or a recovery point (e.g., the target is a shipboard recovery point for the aircraft 100). An example block 212 corresponds to a relative navigation estimator, an example block 214 corresponds to a heading (e.g., a magnetometer-measured heading, etc.), an example block 216 corresponds to guidance logic, and an example block 218 corresponds to aircraft/aerial vehicle (AV) dynamics and control. Further, in some examples, a block 220 corresponds to global navigation.

According to examples disclosed herein, the aforementioned block 210 corresponds to measuring and/or determining orientations of the image device 112 as the image device 112 is directed, moved and/or caused to face toward a target (e.g., stabilized toward the target). According to some examples disclosed herein, a stabilized image-based tracking is presumed. Accordingly, image-based tracking is a common ISR operational aid that utilizes readily available image processing techniques to drive gimbal angles and, thus, maintain the image device 112 centered on the target, which can be a ship to which the aircraft 100 is to land on, for example.

With respect to the example block 202, flight sensor information is gathered and/or analyzed while the image device 112 tracks the target. According to some examples disclosed herein, the aircraft 100 is stabilized (e.g., stabilized in orbit) with a micro-electromechanical systems (MEMS) based inertial measurement unit (IMU), an air-data system for air speed and barometric altitude. Further orientations of the aiming device 113 and/or the image sensor 112, including payload gimbal signals, are available. For global navigation, it may be assumed that magnetometer signals are available.

With respect to the example block 204, relative navigation estimates are determined via the aforementioned example estimator corresponding to the block 212. In this example, a closed loop control of a navigation estimator that is based on standard onboard sensors and payload orientation is utilized with guidance logic corresponding to the block 216, which can correspond to existing guidance logic.

According to examples disclosed herein, at the block 218, the aircraft 100 is assumed to make coordinated turns, which may be captured in a planar kinematics model of the air vehicle in wind.

In the illustrated example, the estimator corresponding to the block 212 can derive, calculate and/or estimate an inertial position, velocity, and wind from the payload orientation corresponding to the aircraft 100. In some examples, original or pre-existing guidance logic may be used in conjunction with the aforementioned estimator.

According to some examples, at block 220, if a known target position, such as a ship location is transmitted or otherwise known, then coordinates corresponding to the ship location can be utilized to provide the vehicle 100 with global navigation information.

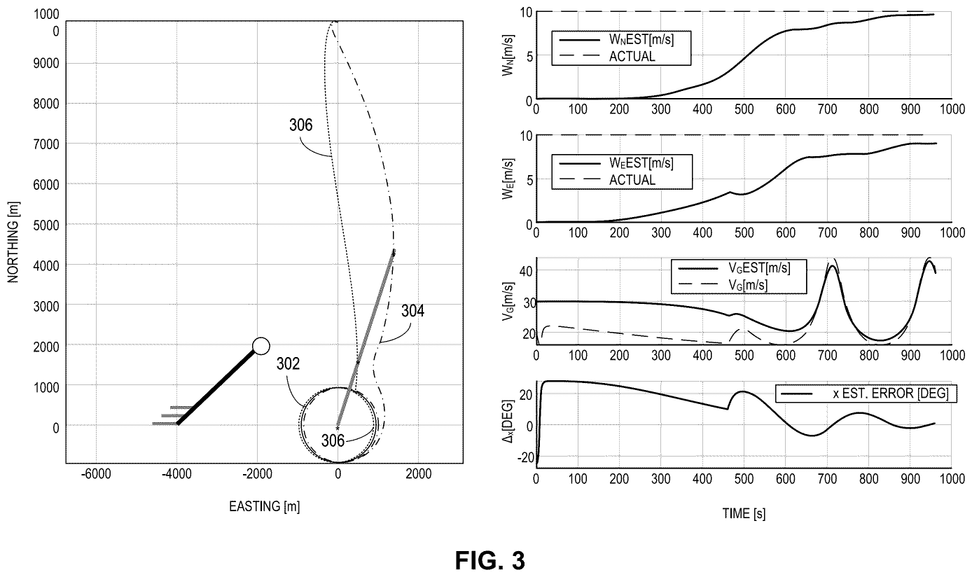

FIG. 3 illustrates example results that can be obtained with examples disclosed herein. In this example, a payload-based estimator (e.g., a payload-based navigation estimator) is utilized with a closed loop control, as well as conventional guidance laws. In this particular example, the aircraft 100 shown in FIG. 1 is exposed to relatively strong winds from a direction of 225 degrees (deg) at 27.5 knots (Kts), with the aircraft 100 at a true airspeed of 58 Kts. In the illustrated example of FIG. 3, a line 302 corresponds to a commanded orbit, a line 304 corresponds to a true location, and a line 306 corresponds to an indication of estimated position. FIG. 3 also depicts an estimated error in vehicle due course, denoted as Δₓ.

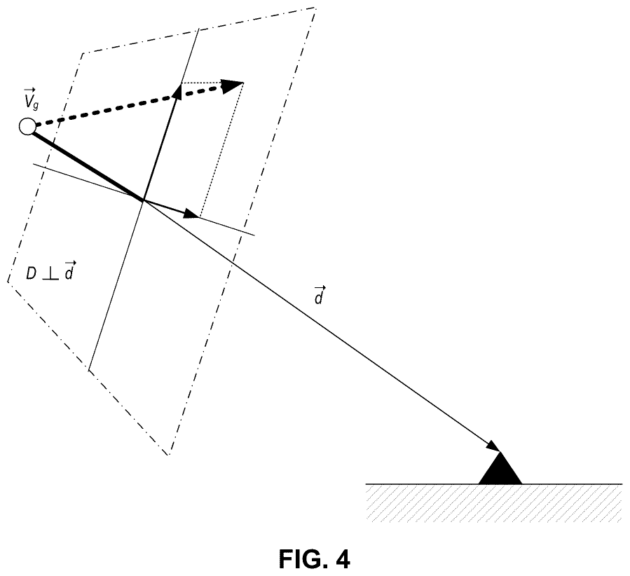

As mentioned above, the estimator is in a closed control loop. In this example, the estimator utilizes zero initialization with 1 hertz (Hz). The example result suggests that an approach to and subsequent orbiting of a target, such as a remote ship, can be supported with payload orientation information (e.g., payload orientation information alone). In connection with FIG. 4 below, examples disclosed herein enable robust estimation results that can be obtained in typical ISR mission flight conditions.

FIG. 4 illustrates example aspects of a formal observability condition with respect to examples disclosed herein. In this example, the formal observability condition for estimation of range and drift from bearing-angles is depicted in FIG. 4. Further, FIG. 4 illustrates that motion in two directions perpendicular to a line-of-sight can advantageously be utilized in examples disclosed herein. In this example, a formal condition for estimation convergence (e.g., observability) of the distance and wind drift is PE, which can imply continuous maneuvering in two directions perpendicular to the line-of-sight.

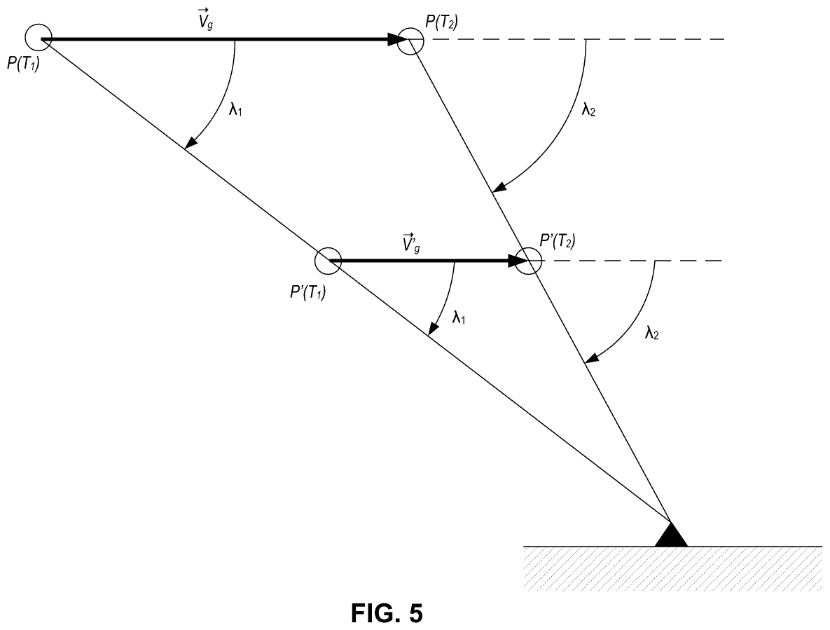

FIG. 5 depicts an example notional aspect of an estimation problem. FIG. 5 depicts an observability problem such that it can be difficult or not possible to distinguish between two scenarios, {p(t₁), p(t₂), V_{g}} and

$$\{ {p}^{′} ( {t}_{1} ) , {p}^{′} ( {t}_{2} ) , {V}_{g}^{′} \} ,$$

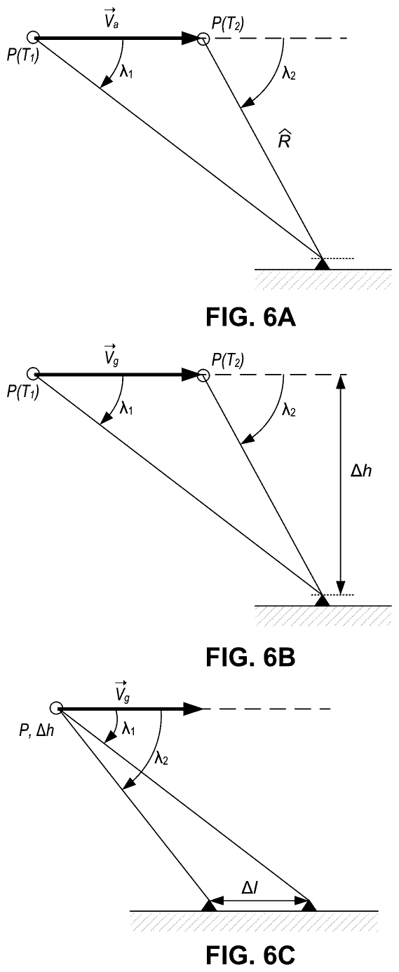

unless there is a sense of scale. In the illustrated example of FIG. 5, a notional depiction of an estimation problem illustrating that if traveling in a horizontal plane and only angles λ₁ and λ₂ are known, then it can be difficult to determine speed and distance. Accordingly, a problem inherent to bearing-only estimation is one of scaling. However, a solution to scaling that can be implemented in examples disclosed herein is described below in connection with FIGS. 6A-6C.

FIGS. 6A-6C illustrates example aspects of scaling that can be implemented in examples disclosed herein. In particular, the examples of FIGS. 6A-6C correspond to multiple possibilities to address scaling mentioned above in connection with FIG. 5.

In FIG. 6A, an example corresponding to a “no-wind” assumption for range estimation. In this example, a principle of Grossman's range estimation from the payload orientation is depicted. An assumption can be that inertial velocity is known can correspond to assuming that there is no wind. However, such an assumption may not be appropriate for relatively small aircraft or UAV operations and, consequentially, vehicle guidance must rely heavily on robustness and conservative precautions.

FIG. 6B depicts observability utilizing an altimeter. The example of FIG. 6B indicates a principle of examples disclosed herein. Particularly, a measured barometric pressure can be relied on to determine a distance of an aircraft above a ship. Accordingly, payload angles are utilized to estimate a location of the aircraft and inertial speed. Access to aircraft airspeed and heading enables information of wind speed and direction to be utilized for aircraft guidance.

Turning to FIG. 6C, observability utilizing geometric matching and associated image processing is depicted. According to some examples, a potential use of image-matching and database derived position depicted in FIG. 6C provides an alternative example methodology to obtain position estimates that may be more accurate than simply utilizing a payload orientation-based method. However, such a method may utilize a significant degree of computational loading, and can also necessitate availability of a terrain database, and restrictions on payload motion.

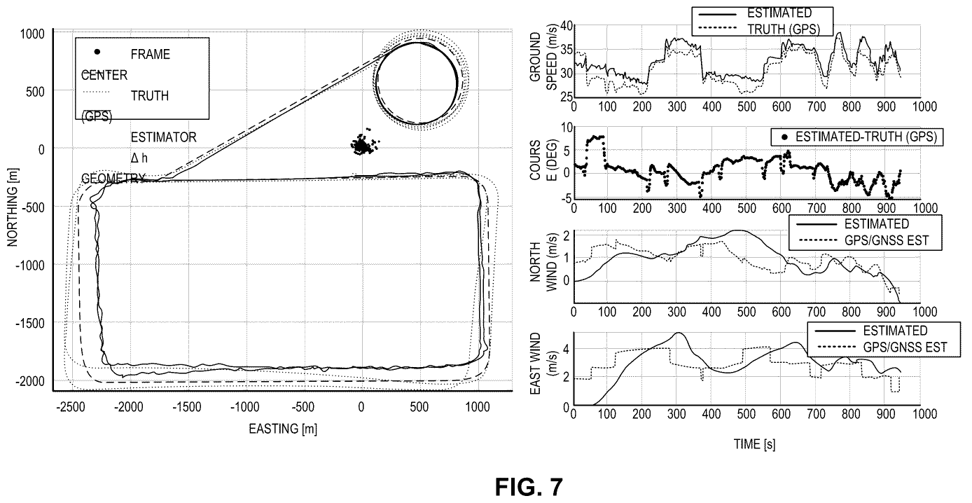

FIGS. 7-9B illustrate example utilization of a payload estimator that can be implemented in examples disclosed herein. FIG. 7 illustrates example utilization of a payload estimator. In this example, a non-GNSS/GPS payload-orientation-based estimator applied during a rectangular flight pattern is subsequently followed by transition to a relatively small orbit. The offset between geometric results and GPS traces are caused by the difference between barometric altitude and a World Geodetic System 1984 (WGS84) global coordinate system altitude. The rate estimation performance with wind estimate is initialized at zero.

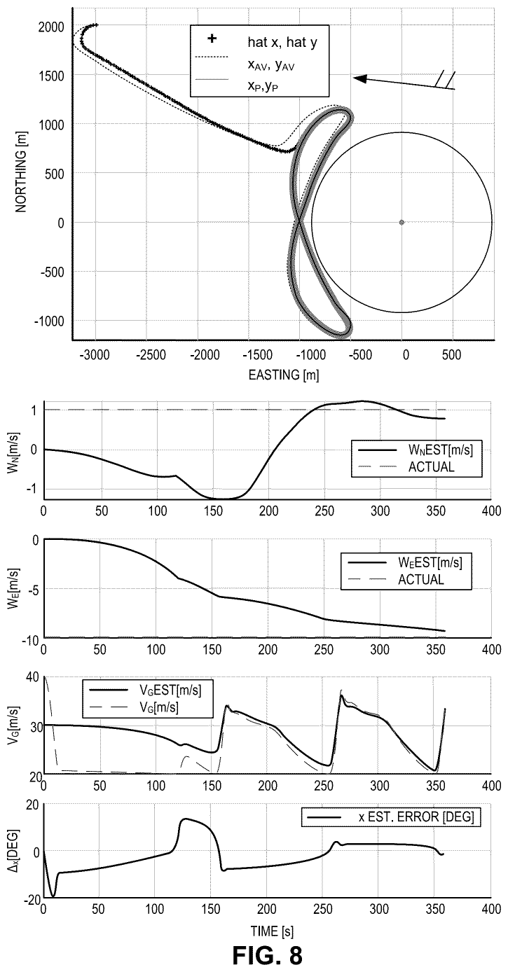

Turning to FIG. 8, an example utilization of a stand-off pattern is shown. In this example, an aircraft is oriented toward the wind, such that movement along a stand-off pattern minimizes bank saturation, thereby increasing target exposure and, thus, improving navigation state estimation.

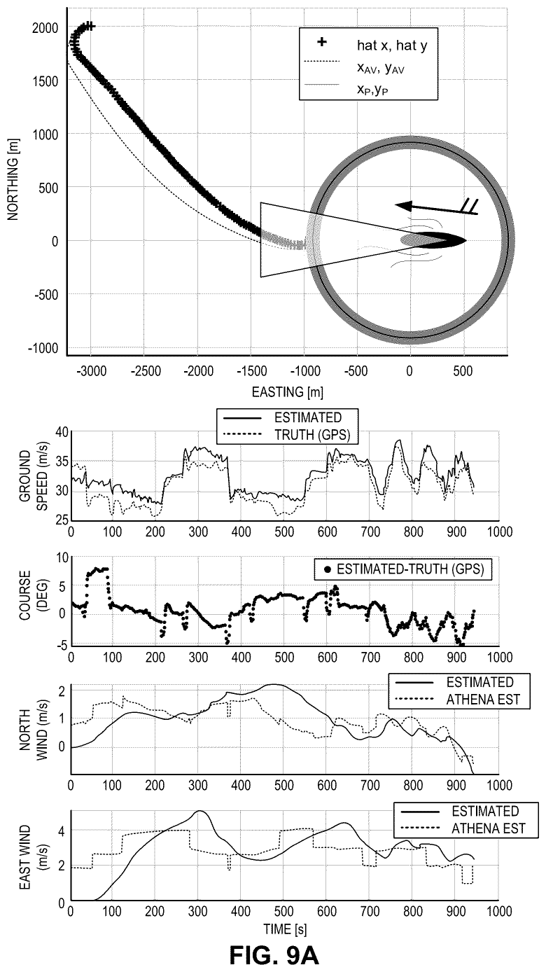

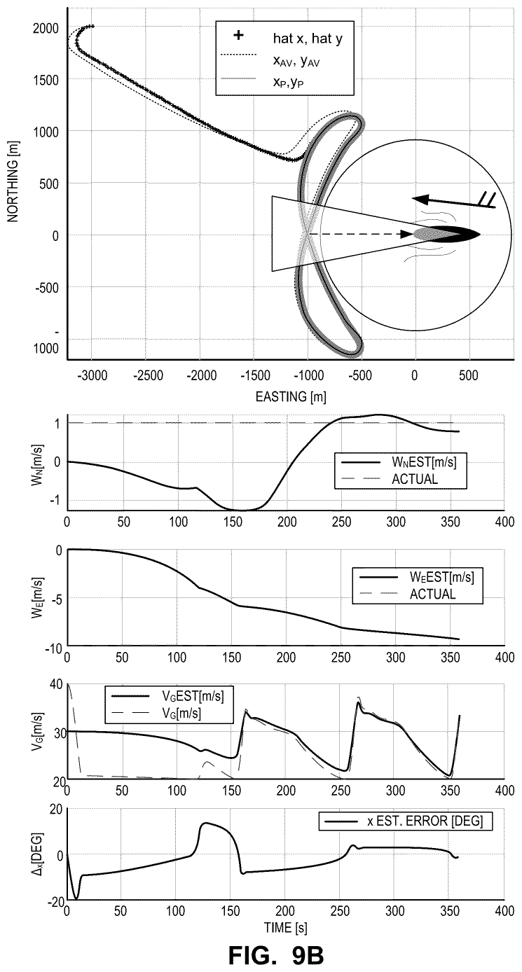

FIGS. 9A and 9B correspond to a proposed payload-orientation-based estimator that feeds existing guidance logic to approach and robustly orbit a moving ship, or trail the ship with a stand-off maneuver that accommodates observation and the acquisition of final approach for recovery via the ship, for example.

FIG. 9A depicts an example of a ship-relative orbit, that provides advantageous coverage (e.g., top-view coverage) while further accommodating relatively accurate relative-navigation state estimation (bottom traces). The orbit depicted in FIG. 9A can enable utilization of existing guidance logic, despite a lack of access to GNSS signals.

FIG. 9B depicts an example of a maneuver for trailing a ship. In the illustrated example of FIG. 9B, the stand-off pattern reduces and/or minimizes bank saturation, and, thus, can increase and/or maximize ship exposure. Consequently, a relative-navigation state estimation is improved, thereby enabling acquisition of favorable approach conditions.

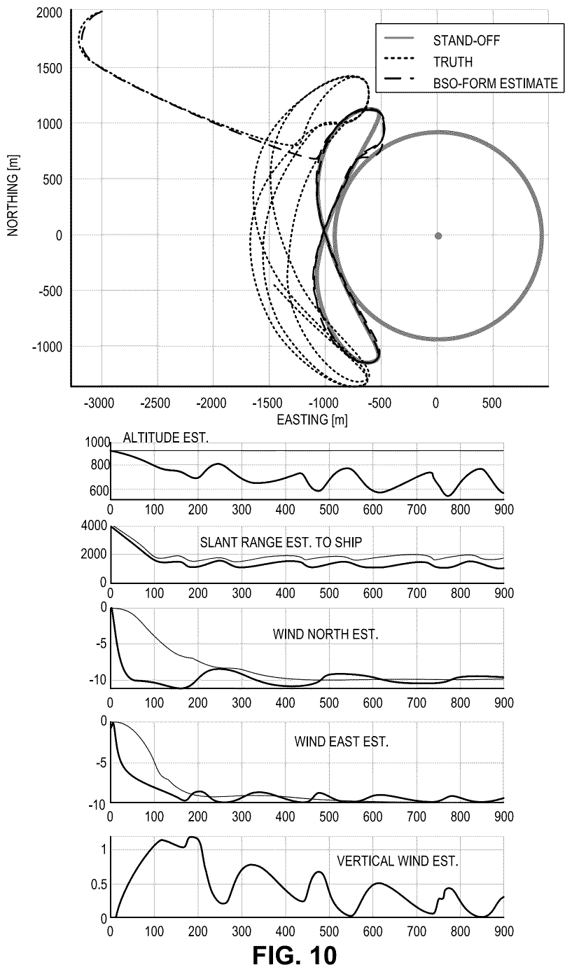

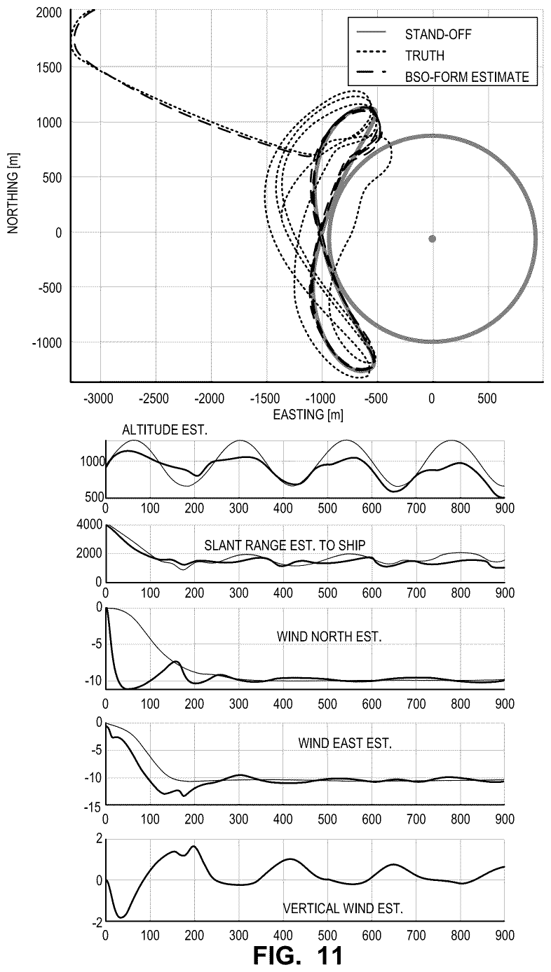

FIGS. 10 and 11 illustrate a comparison with results in known implementations. FIGS. 10 and 11 demonstrate that a stand-off maneuver at a relatively constant altitude is not robustly feasible when utilizing estimators in known implementations. Turning to FIG. 10, a lack of altitude variation causes a significant error in estimated altitude which, in turn, causes an associated bias in position estimation and, thus, relatively poor performance in path following behavior.

FIG. 11 depicts observability that is somewhat improved in comparison to that of FIG. 10. In the view of FIG. 11, the observability with continuous +/−1000 ft altitude variation is not sufficient for a full position convergence in this 15 minute flight.

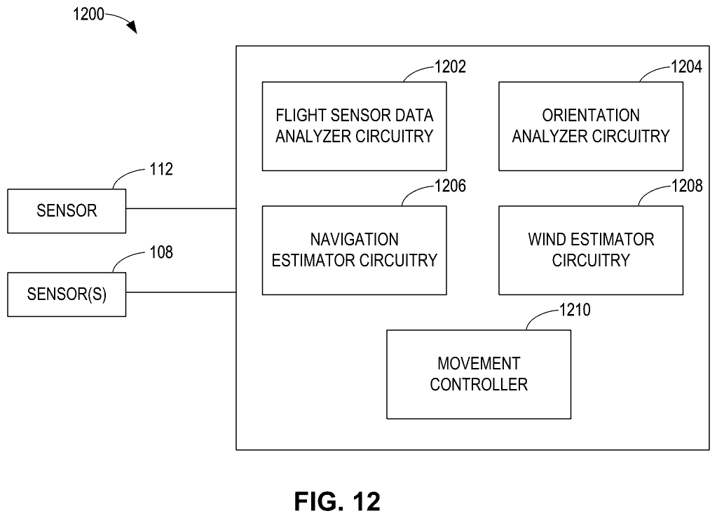

FIG. 12 is a block diagram of an example implementation of a payload orientation analysis system 1200 for navigation of an aircraft (e.g., a UAV, an AV, etc.). The example payload orientation analysis system 1200 can be implemented in and/or communicatively coupled to the controller 110 shown in FIG. 1. The payload orientation analysis system 1200 of FIG. 12 may be instantiated (e.g., creating an instance of, bring into being for any length of time, materialize, implement, etc.) by programmable circuitry such as a Central Processor Unit (CPU) executing first instructions. Additionally or alternatively, the payload orientation analysis system 1200 of FIG. 12 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 12 may, thus, be instantiated at the same or different times. Some or all of the circuitry of FIG. 12 may be instantiated, for example, in one or more threads executing concurrently on hardware and/or in series on hardware. Moreover, in some examples, some or all of the circuitry of FIG. 12 may be implemented by microprocessor circuitry executing instructions and/or FPGA circuitry performing operations to implement one or more virtual machines and/or containers.

The payload orientation analysis system 1200 of the illustrated example includes example flight sensor data analyzer circuitry 1202, example orientation analyzer circuitry 1204, example navigation estimator circuitry 1206, example wind estimator circuitry 1208, and example movement controller circuitry 1210. According to examples disclosed herein, the payload orientation analysis system 1200 is communicatively coupled to the flight sensor(s) 108 as well as the image sensor 112.

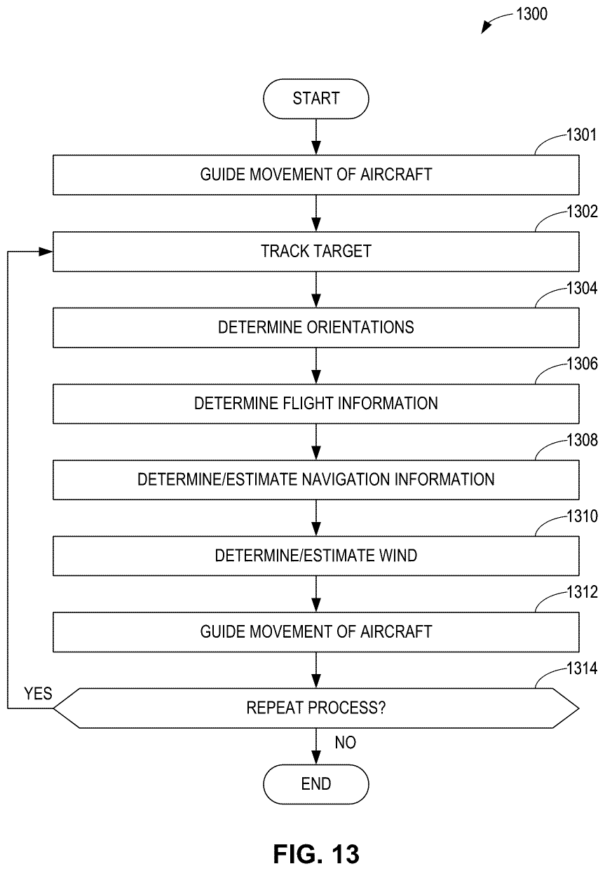

The flight sensor data analyzer circuitry 1202 of the illustrated example is implemented to obtain, access and/or receive sensor data from the flight sensor(s) 108 and/or the image sensor 112. According to examples disclosed herein, the flight sensor data analyzer circuitry 1202 can utilize data (e.g., inertial data, movement data, barometric pressure data, etc.) from the flight sensor(s) 108 as well as image data from the image sensor 112. In turn, the image data can be utilized to track a target, such as a ship at sea for recovery and/or landing of the aircraft, for example. Particularly, examples disclosed herein can be utilized for landing the aircraft onto the ship and can advantageously enable the aircraft to land accounting for movement of the ship as well as wind/air effects on a deck or other landing surface of the ship. In some examples, the flight sensor data analyzer circuitry 1202 is instantiated by programmable circuitry executing flight sensor data analyzer instructions and/or configured to perform operations such as those represented by the flowchart of FIG. 13.

According to examples disclosed herein, the orientation analyzer circuitry 1204 is utilized to determine, analyze and/or characterize orientations and/or movement of the image sensor 112 and/or the gimbal as the image sensor 112 is moved to track the aforementioned target. In some examples, the orientation analyzer circuitry 1204 utilizes gimbal data (e.g., inertial gimbal data, gimbal movement data, rotational movement data, angular speed/acceleration data, angular speed, angular acceleration, etc.) corresponding to movement of the image sensor 112 as the image sensor 112 is utilized to track the target via the gimbal. In this example, the orientation analyzer circuitry 1204 characterizes and/or determines the orientation data as the target is being tracked by the image sensor 112. In some examples, the orientation analyzer circuitry 1204 is instantiated by programmable circuitry executing orientation analyzer instructions and/or configured to perform operations such as those represented by the flowchart of FIG. 13.

In this example, the navigation estimator circuitry 1206 is utilized to determine navigation information based on the aforementioned orientations of the image sensor 112 that are measured as the image sensor 112 is moved to track the target along with flight data (e.g., flight instrumentation data, inertial data, barometric data, etc.) corresponding to the flight sensor(s) 108. According to examples disclosed herein, the navigation estimator circuitry 1206 determines a position and/or orientation of the aircraft relative (e.g., a relative position, a relative orientation, etc.) to the target. In some examples, the navigation estimator circuitry 1206 is instantiated by programmable circuitry executing navigation estimator instructions and/or configured to perform operations such as those represented by the flowchart of FIG. 13.

In some examples, the wind estimator circuitry 1208 is implemented to estimate, calculate and/or determine wind encountered by the aircraft. In some such examples, the wind estimator circuitry 1208 may be implemented to determine wind effects and/or air movement near a landing area (e.g., a ship deck) as the aircraft is approaching and/or landing thereon. For example, the wind estimator circuitry 1208 can determine and/or characterize localized wind or air effects encountered by the aircraft as the aircraft approaches the landing area (e.g., wind encountered, effects of air propulsion of the aircraft on the landing area, etc.). In some examples, the wind estimator circuitry 1208 is instantiated by programmable circuitry executing wind estimator instructions and/or configured to perform operations such as those represented by the flowchart of FIG. 13.

In the illustrated example of FIG. 12, the movement controller circuitry 1210 is implemented to control and/or guide movement of the aircraft. According to examples, the movement of the aircraft can be based on the determined navigation information. Additionally or alternatively, the movement of the aircraft is controlled based on the determined wind and/or wind effects. In some examples, the movement controller circuitry 1210 controls the aircraft to orbit and/or maneuver relative to the target (e.g., the aircraft is controlled to move along the target in a figure eight path, an orbit and/or a stand-off path, etc.). In some examples, the movement controller circuitry 1210 is instantiated by programmable circuitry executing movement controller instructions and/or configured to perform operations such as those represented by the flowchart of FIG. 13.

Examples disclosed can implement the following calculations, methodology and/or estimation techniques. However, any other appropriate calculations, methodology and/or estimation techniques can be implemented instead. Example methodology disclosed herein utilizes kinematics. Examples disclosed herein can be applicable to any fixed wing configuration aircraft (or other appropriate type of aircraft) that carries a directed or aimed payload, for example a gimballed camera, a fixed wide-angle camera with known orientation, or a phased array type sensor, etc.

According to examples disclosed herein, an aircraft may be represented in kinematics as follows in example Equations 1-6:

$${\dot{x}}_{N} = {V}_{{a}^{C} ψ} + {w}_{N} \qquad ( 1 )$$

$${\dot{y}}_{E} = {V}_{{a}^{S} ψ} + {w}_{E} \qquad ( 2 )$$

$$\dot{ψ} = {u}_{ψ} \qquad ( 3 )$$

$$\dot{φ} = {u}_{φ} \qquad ( 4 )$$

$$\dot{κ} = {u}_{κ} \qquad ( 5 )$$

$$\dot{λ} = {u}_{λ} , \qquad ( 6 )$$

where {x_{N}, y_{E}} represent position North and East, the orientation is given by heading angle ψ and bank angle φ, and the camera is oriented with pan and tilt angles, respectively, denoted as κ and λ. In this example, Vₐ represents the airspeed that is set based on aircraft characteristics and typically compromises on airspeed tracking are not accepted. According to examples disclosed herein, it can be assumed that appropriate autopilot functions are operational and/or working within acceptable parameters such that Vₐ≡Vₐ_{_{c}}. Typically, bank angle dynamics on most conventional fixed wing aircraft can follow the commanded bank angle rate at a relatively high bandwidth. Thus, it is reasonable to assume that the tracking of a ground target and the associated orbit of the aircraft occurs at a relatively lower bandwidth as well as a lower bank angle rate that is approximated with a quick first order response to the commanded bank angle, as follows in example Equation 7.

$${u}_{φ} = - φ / {τ}_{φ} + {φ}_{c} / {τ}_{φ} \qquad ( 7 )$$

Most fixed-wing aircraft/AVs are configured to perform coordinated turns, typically relying on inertial sensors, and therefore it is assumed that:

$${u}_{ψ} = \frac{g}{{V}_{a}} tan φ \qquad ( 8 )$$

Accordingly, signals u_{κ} and u_{λ} are driven by image-processing and/or inertial stabilization logic. According to examples disclosed herein, wind in North and East directions, denoted as w_{N} and w_{E} respectively, is unknown and estimated based on other signals and/or additional measurements.

Examples disclosed herein can enable navigation (in the absence of GNSS signals) and guidance from observation of a remote ship, which can be combined with vehicle heading to estimate relative position as well as a wind-over-deck. According to some examples disclosed herein, the estimator is demonstrated based on the assumption corresponding to FIG. 6B. To verify estimator applicability and performance, the estimator is demonstrated by using actual telemetry to reproduce the aircraft location and compare it to ‘truth’ data. The standard telemetry includes time-stamped payload signals and wind estimates from a commercial autopilot product/system, which can be GNSS/GPS based. Example results from application in straight and circular flight are displayed in FIG. 7. These example results were obtained with a non-linear Kalman Filter formulation of the aforementioned estimator.

Examples disclosed herein can implement a state propagation model. To that end, estimated states can include a horizontal position relative to the target, ground speed and its direction, and wind components:

$$x = {( \begin{matrix}Δ {P}_{N} & Δ {P}_{E} & Δ h & {W}_{N} & {W}_{E} & ψ\end{matrix} )}^{T}$$

Airspeed and bank-angle can be considered as external inputs. The commanded bank-angle is equivalent to a commanded turn-rate through the coordinated turn condition. Accordingly, altitude regulation can be taken into account via the airdata system as an independent signal, which is akin to a ‘flat-earth’ assumption, albeit with the possibility of some barometric variation addressed later. Consider therefore the control signal:

$$u = {( \begin{matrix}{V}_{a} & {ω}_{c} & {γ}_{c}\end{matrix} )}^{T}$$

Note that γ_{c}≈\dot{h}_{c}/Vₐ and that the ISR-mission tasks are performed with \dot{h}_{c}(t)=0.

According to examples disclosed herein, a propagation model \dot{x}=f(x, u) is expressed as:

$$Δ {\dot{P}}_{N} = {W}_{N} + {V}_{a} cos ψ$$

$$Δ {\dot{P}}_{E} = {W}_{E} + {V}_{a} sin ψ$$

$$Δ \dot{h} = {V}_{a} {γ}_{c}$$

$${\dot{W}}_{N} = {\dot{W}}_{E} = 0$$

$$\dot{ψ} = {ω}_{c}$$

Examples disclosed herein can utilize a measurement model. Accordingly, measurements can include payload orientation signals:

$$y = {( \begin{matrix}λ & β & \dot{λ} & \dot{β}\end{matrix} )}^{T} \qquad ( 9 )$$

For notational convenience, according to examples disclosed herein, range and horizontal range can be represented as follows:

$$R {=}^{Δ} \sqrt{Δ {P}_{N}^{2} + Δ {P}_{E}^{2} + Δ {h}^{2}} \qquad ( 10 )$$

$${R}_{h} {=}^{Δ} \sqrt{Δ {P}_{N}^{2} + Δ {P}_{E}^{2}} \qquad ( 11 )$$

According to examples disclosed herein, the measurement model y=H(x, u) can be expressed as:

$$λ = arctan \{ Δ h / {R}_{h} \} \qquad ( 12 )$$

$$β = ( arctan \{ Δ {P}_{E} / Δ {P}_{N} \} - π ) - ψ \qquad ( 13 )$$

$$\dot{λ} = \frac{{V}_{a} {γ}_{c} {R}_{h}^{2} - Δ h ( Δ {P}_{N} {V}_{N} + Δ {P}_{E} {V}_{E} )}{{R}_{h} {R}^{2}} \qquad ( 14 )$$

$$\dot{β} = \frac{( Δ {P}_{N} {V}_{E} - Δ {P}_{E} {V}_{N} )}{{R}_{h}^{2}} - {ω}_{C} , \qquad ( 15 )$$

$$where$$

$${V}_{N} = {W}_{N} + {V}_{a} cos ψ$$

$${V}_{E} = {W}_{E} + {V}_{a} sin ψ$$

According to examples disclosed herein, some useful variations of measurement model example Equation 9 can be utilized in a Kalman-Filter like formulation. For example, direct heading measurements can be relatively noisy and possibly biased. Accordingly, standard models can be used to augment the measurement model. Similarly, over a relatively long mission, temporal or spatial variations in barometric pressure, which affects altitude estimates, can be accounted for in the measurement model.

If the ship location is transmitted or otherwise known, then the formulation can be combined with the vehicle heading estimate to estimate vehicle position. The altitude can be considered as an independent variable governed by barometric pressure sensors, and with known height of the ship location, Δh is defined as the barometric height above ship.

$$y = {( \begin{matrix}λ & β & \dot{λ} & \dot{β} & {Λ}_{N} & {Λ}_{E}\end{matrix} )}^{T}$$

According to examples disclosed herein, estimated states include a horizontal position relative to the ship, ground speed and a direction of ship, and wind components:

$$x = {( \begin{matrix}Δ {P}_{N} & Δ {P}_{E} & {V}_{N} & {V}_{E} & {W}_{N} & {W}_{E}\end{matrix} )}^{T} , where$$

$$Δ {P}_{N} {=}^{Δ} {x}_{A V} - {x}_{tgt} , Δ {P}_{E} {=}^{Δ} {y}_{A V} - {y}_{tgt} , and \{ {x}_{tgt} , {y}_{tgt} \}$$

indicates the known ship location. Examples disclosed herein consider airspeed and bank-angle as external inputs. The commanded bank-angle is equivalent to a commanded turn rate through the coordinated turn condition. Furthermore, altitude regulation can be regarded by the airdata system as an independent signal, which is akin to a ‘flat-earth’ assumption, albeit with the possibility of some barometric variation addressed later. According to examples disclosed herein, the control signal can be shown as below:

$$u = {( \begin{matrix}{V}_{a} & {ω}_{c} & Δ h\end{matrix} )}^{T}$$

Examples disclosed herein can implement measurement models. For notational convenience, define range and horizontal range can be represented in the following example expressions:

$$R {=}^{Δ} \sqrt{Δ {P}_{N}^{2} + Δ {P}_{E}^{2} + Δ {h}^{2}} \qquad ( 16 )$$

$${R}_{h} {=}^{Δ} \sqrt{Δ {P}_{N}^{2} + Δ {P}_{E}^{2}} \qquad ( 17 )$$

According to examples disclosed herein, payload angles and their corresponding rates are measured and unknown prevailing wind is accounted for with two pseudo measurements. The measurement models can be expressed as the following.

$$λ = arctan \{ Δ h / {R}_{h} \} \qquad ( 18 )$$

$$β = ( arctan \{ Δ {P}_{E} / Δ {P}_{N} \} - π ) - ψ \qquad ( 19 )$$

$$\dot{λ} = \frac{- Δ h ( Δ {P}_{N} {V}_{N} + Δ {P}_{E} {V}_{E} )}{{R}_{h} {R}^{2}} \qquad ( 20 )$$

$$\dot{β} = \frac{( Δ {P}_{N} {V}_{E} - Δ {P}_{E} {V}_{N} )}{{R}_{h}^{2}} - {ω}_{c} \qquad ( 21 )$$

$${Λ}_{N} = {V}_{N} - {V}_{a} cos ψ - {W}_{N} \qquad ( 22 )$$

$${Λ}_{E} = {V}_{E} - {V}_{a} sin ψ - {W}_{E} \qquad ( 23 )$$

Examples disclosed herein can also implement further variations. In a particular example, heading information can be added, given that this is a continuously changing controlled variable, with measurements possibly corrupted with EMI effects can be considered. Also, examples disclosed herein can take into account barometric altitude, as barometric altitude can tend to be different from geometric altitude. However, it has been seen that altitude is not effectively observable, so caution should be exercised with respect to use of the estimates.

$$y = {( \begin{matrix}λ & β & \dot{λ} & \dot{β} & {Λ}_{N} & {Λ}_{E} & \tilde{ψ} & \text{?}\end{matrix} )}^{T}$$

According to examples disclosed herein, estimated states can include a delta position relative to a ship (or other target), ground speed in conjunction with direction, as well as wind components:

$$x = {( \begin{matrix}Δ {P}_{N} & Δ {P}_{E} & {V}_{N} & {V}_{E} & {W}_{N} & {W}_{E} & \hat{ψ} & \text{?}\end{matrix} )}^{T}$$

A measured heading is derived from magnetometer measurements or from a complementary filtered solution as:

$$\tilde{ψ} = {ψ}^{*} + {μ}_{ψ}$$

According to examples disclosed herein, a predicted value is computed as:

$${\hat{ψ}}^{-} ( {t}_{k} ) = {h}_{7} ( {\hat{x}}_{k}^{-} , u ( {t}_{k} ) ) = {C}_{7} {\hat{x}}_{k}^{-} , \qquad ( 24 )$$

whereas its propagation is obtained from control input with a coordinated turn condition

$$\dot{ψ} ( t ) = {ω}_{c} ( t ) + {v}_{ψ}$$

The altitude measurement is baro-inertial and may exhibit a consistent offset compared to the geometric altitude (WGS84 that can be expressed as follows:

$${\text{?}}_{b a r o} = Δ {h}^{*} + δ h + {μ}_{h} \qquad ( 25 )$$

The predicted altitude can be expressed as:

$$\text{?} = {C}_{8} \hat{x}$$

The model for propagation can be expressed as:

$$\text{?} = 0 + {v}_{h} .$$

Accordingly, example Equations 16-25 can be represented as: y=H(x, u) and a corresponding Jacobian

$$\frac{d H ( x , u )}{d x}$$

can be utilized for an EKF formulation.

In a first observation, the δh offset may be ignored at the price of some bias in the geometry, which will trickle down to the estimates. Furthermore, δh can vary with altitude, presumably caused by non-standard lapse-rate of temperature, in which case it's feasible to enable its estimate with OAT measurement. In a second observation, a commanded or measured climb rate can be utilized as a predictive model [symbol] =\dot{h}_{c}.

Examples disclosed herein can utilize a combination of approach choreography and airdata. Particularly, examples disclosed herein can utilize a barometric pressure measurement to give an idea of altitude above ground level (AGL). In fact, it is our source of vertical distance to a special point of interest (SPOI), which may be based on a locally flat-earth assumption. Actual altitude to the ship may thus include unknown error, δh, with components including: (i) digital terrain elevation data (DTED) error (e.g., error in SPOI altitude data, etc.), (ii) altimeter setting error (e.g., a difference between a world geodetic system (WGS84) mean sea level (MSL) and an altimeter reference, etc.), and (iii) non-standard lapse rate error (e.g. an atmospheric inversion layer).

Estimation of wind is coupled to the altitude error. This may be seen with an example as follows considering the two conditions including geometric and kinematic conditions:

$${R}_{h} = \frac{Δ h}{tan λ}$$

The following is a kinematic expression:

$${\dot{R}}_{h} = \frac{Δ \dot{h}}{tan λ} - \frac{Δ h \dot{λ}}{{sin}^{2} λ}$$

Suppose the aircraft is flying due North directly at the SPOI at a relatively constant altitude (Δ\dot{h}=0), then:

$${\dot{R}}_{h} = {V}_{ℊ} = {V}_{a} + {W}_{N}$$

It can be assumed that there is an error in the measured altitude such that Δh=Δh*+δh. If wind is unknown and to be estimated, the error in altitude results in a position error can be expressed as:

$$δ R = \frac{δ h}{tan λ}$$

and an error in estimated ground speed can be expressed as:

$$δ {V}_{ℊ} = δ W = \frac{λ}{{sin}^{2} λ} δ h$$

While the position error can be substantially equal to the error in altitude, at nominal airspeed and wind of 10 meters per second (m/s), an error δh=100 meters (m) can imply an error in wind estimate of approximately δW≈2 m/s. In fact, application of known implementations suggests that constant maneuvering and proximity may be necessitated to enable simultaneous estimation with bounded errors or zero errors. Given the nature of wind fields over orbit (e.g., non-uniformity of the wind field), relatively slow orbiting rates and associated payload angle changes, and typical lack of vertical maneuvers in proximity of a ship, known implementations cannot generally count on estimating both altitude error and unknown wind simultaneously. Therefore, examples disclosed herein can rely instead on a combination of choreography of the approach procedure, traditional air data sensing, and possibly information from the ship.

Examples disclosed herein can utilize payload orientation-based maneuvering for ship-board aircraft recovery, Accordingly, examples disclosed herein utilize robust approach to ship and subsequent orbiting. According to examples disclosed herein, an estimator in a control loop as represented in FIG. 2 can be combined in an aircraft and environment simulation to realistically demonstrate a performance of the aircraft during actual operation. Accordingly, examples disclosed herein can implement a closed dynamics loop where the payload provides position and velocity estimates to existing guidance logic. Accordingly, such an implementation of a closed dynamics loop is significant because it can demonstrate coupled estimator controller behavior. In contrast, most known guidance logic utilizes a combination of waypoint processing into path segments with path following logic based on projections or cross-track error.

According to examples disclosed herein, when the output from the estimator, such as the example estimator corresponding to block 212 of FIG. 2, is combined with guidance logic, orbiting can be achieved seamlessly with existing control signal infrastructure. Examples disclosed herein can be utilized for stabilized stand-off maneuver for final approach acquisition. For example, if the payload-based estimator is used to feed an existing guidance logic, then more complex maneuvers can also be commanded, for instance a stand-off maneuver as demonstrated in FIG. 8. Similar to the orbiting logic, the observability benefits from proximity and a path perpendicular to the line-of-sight. This implies that the estimator naturally accommodates both the orbit and the stand-off ship observation maneuvers.

Examples disclosed herein are distinct from known implementations. In known implementations, formalizations provide similar capabilities and formally specify the conditions under which a stable convergent estimation can be made. These conditions correspond to PE and imply a need for constant significant maneuvering relative to the target (e.g., continuous motion in multiple directions). As mentioned above, reliance on maneuvers in altitude is not a pragmatic approach for ISR tasks or for terminal operations which, therefore, favor the approach presented in the present disclosure, which takes advantage of a persistence in excitation in the horizontal plane that is naturally associated with ship observation. Representative performance comparisons are mentioned above in connection with FIGS. 10 and 11.

While an example manner of implementing the payload orientation analysis system 1200 of FIG. 12 is illustrated in FIG. 12, one or more of the elements, processes, and/or devices illustrated in FIG. 12 may be combined, divided, re-arranged, omitted, eliminated, and/or implemented in any other way. Further, the example flight sensor data analyzer circuitry 1202, the example orientation analyzer circuitry 1204, the example navigation estimator circuitry 1206, the example wind estimator circuitry 1208, the example movement controller circuitry 1210, and/or, more generally, the example payload orientation analysis system 1200 of FIG. 12, may be implemented by hardware alone or by hardware in combination with software and/or firmware. Thus, for example, any of the example flight sensor data analyzer circuitry 1202, the example orientation analyzer circuitry 1204, the example navigation estimator circuitry 1206, the example wind estimator circuitry 1208, the example movement controller circuitry 1210, and/or, more generally, the example payload orientation analysis system 1200, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example payload orientation analysis system 1200 of FIG. 12 may include one or more elements, processes, and/or devices in addition to, or instead of, those illustrated in FIG. 12, and/or may include more than one of any or all of the illustrated elements, processes and devices.

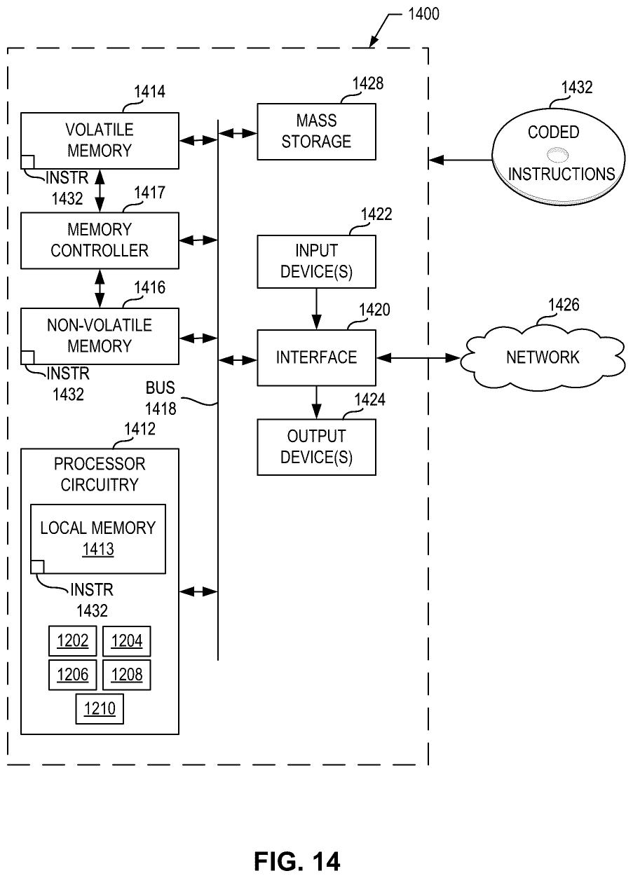

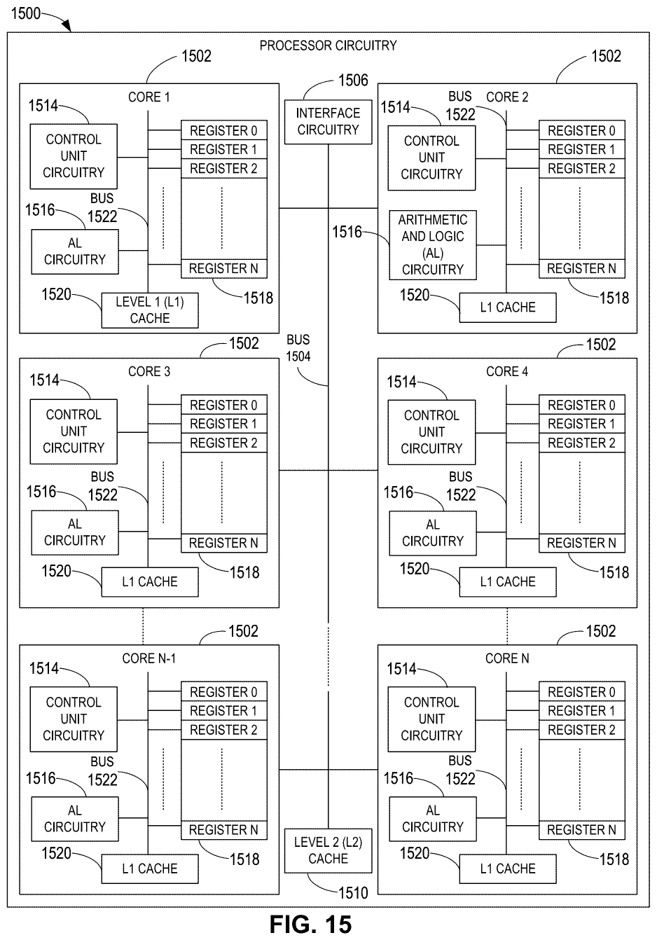

A flowchart representative of example machine readable instructions, which may be executed by programmable circuitry to implement and/or instantiate the payload orientation analysis system 1200 of FIG. 12 and/or representative of example operations which may be performed by programmable circuitry to implement and/or instantiate the payload orientation analysis system 1200 of FIG. 12, is shown in FIG. 13. The machine readable instructions may be one or more executable programs or portion(s) of one or more executable programs for execution by programmable circuitry such as the programmable circuitry 1412 shown in the example processor platform 1400 discussed below in connection with FIG. 14 and/or may be one or more function(s) or portion(s) of functions to be performed by the example programmable circuitry (e.g., an FPGA) discussed below in connection with FIGS. 15 and/or 16. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 13, many other methods of implementing the example payload orientation analysis system 1200 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 13 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 13 is a flowchart representative of example machine readable instructions and/or example operations 1300 that may be executed, instantiated, and/or performed by programmable circuitry to determine navigation information of an aircraft tracking a target as an aircraft (e.g., the aircraft 100) is maneuvered. The example machine-readable instructions and/or the example operations 1300 of FIG. 13 begin at block 1301, as the example movement controller circuitry 1210 causes and/or directs the aircraft to be maneuvered relative to the target. According to examples disclosed herein, the movement controller circuitry 1210 directs and/or controls the aircraft to orbit the target and/or an area corresponding to the target. Additionally or alternatively, the example movement controller circuitry 1210 directs the aircraft to move in a pattern, such as a figure-8 or a stand-off pattern movement, with respect to the target and/or the area corresponding to the target.

At block 1302, the movement controller circuitry 1210 of the illustrated example causes a gimbal or any other appropriate movement/aiming device to move and/or orient the image sensor to track the target. In this example, the image sensor is moved based on image data from the image sensor to track the target as the aircraft moves relative to the target. In some examples, the movement controller circuitry 1210 coordinates overall movement of the aircraft along with movement of the gimbal based on the tracking of the target. In some such examples, the overall movement of the aircraft is controlled to maintain the target within a field-of-view of the image sensor.

At block 1304, the example orientation analyzer circuitry 1204 determines orientations of the image sensor and/or the gimbal as the image sensor is oriented by the gimbal while tracking the target. According to examples disclosed herein, the example orientation analyzer circuitry 1204 determines orientations of the image sensor and/or the gimbal as the gimbal moves, orients and/or rotates the image sensor to maintain the image sensor oriented (e.g., centered) toward the target as the aircraft is maneuvered relative to the target (orbiting the target, etc.). In some examples, the orientation analyzer circuitry 1204 utilizes gimbal data (inertial gimbal data, movement data, orientation data, etc.) for determination and/or calculation of the orientations.

At block 1306, the example flight sensor data analyzer circuitry 1202 determines, estimates and/or calculates flight information (e.g., flight data, flight sensor information). According to examples disclosed herein, the flight sensor data analyzer circuitry 1202, receives and/or accesses sensor data corresponding to a flight sensor (e.g., the flight sensor(s) 108). The flight information may include, but is not limited to, barometric data, airspeed, pressure data, inertial flight data, movement data, flight information data, aircraft instrumentation measurements, etc.

At block 1308, the example navigation estimator circuitry 1206 determines, estimates and/or calculates navigation information. According to examples disclosed herein, the navigation estimator circuitry 1206 calculates the navigation information based on the orientations and the flight information. In this example, the navigation estimator circuitry 1206 calculates and/or determines a relative position of the aircraft relative to the target based on the orientations and the flight information.

At block 1310, in some examples, the wind estimator circuitry 1208 determines, estimates and/or calculates wind information and/or a wind condition. According to some examples disclosed herein, the wind information and/or the wind condition is utilized to adjust movement of the aircraft. In other words, movement of the aircraft can be at least partially based on the wind information and/or the wind condition. In some examples, the wind estimator circuitry 1208 determines, estimates and/or calculates localized wind effects on a landing area of the aircraft (e.g., a deck of a ship, a landing pad, etc.).

At block 1312, the example movement controller circuitry 1210 guides movement of the aircraft based on the navigation information. In some examples, the movement controller circuitry 1210 utilizes a transmitted position of the target (e.g., a position of a ship on which the aircraft is to land) to determine a position of the aircraft.

At block 1314, it is determined by the example movement controller circuitry 1210 as to whether to repeat the process. If the process is to be repeated (block 1314), control of the process returns to block 1302. Otherwise, the process ends. The determination may be based on whether the target location has been determined or whether the aircraft has successfully landed, for example.

FIG. 14 is a block diagram of an example programmable circuitry platform 1400 structured to execute and/or instantiate the example machine-readable instructions and/or the example operations of FIG. 13 to implement the payload orientation analysis system 1200 of FIG. 12. The programmable circuitry platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, and/or microcontrollers from any desired family or manufacturer. The programmable circuitry 1412 may be implemented by one or more semiconductor based (e.g., silicon based) devices. In this example, the programmable circuitry 1412 implements the example flight sensor data analyzer circuitry 1202, the example orientation analyzer circuitry 1204, the example navigation estimator circuitry 1206, the example wind estimator circuitry 1208, and the example movement controller circuitry 1210.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1400 of the illustrated example also includes one or more mass storage discs or devices 1428 to store firmware, software, and/or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1432, which may be implemented by the machine readable instructions of FIG. 13, may be stored in the mass storage device 1428, in the volatile memory 1414, in the non-volatile memory 1416, and/or on at least one non-transitory computer readable storage medium such as a CD or DVD which may be removable.

FIG. 15 is a block diagram of an example implementation of the programmable circuitry 1412 of FIG. 14. In this example, the programmable circuitry 1412 of FIG. 14 is implemented by a microprocessor 1500. For example, the microprocessor 1500 may be a general-purpose microprocessor (e.g., general-purpose microprocessor circuitry). The microprocessor 1500 executes some or all of the machine-readable instructions of the flowchart of FIG. 13 to effectively instantiate the circuitry of FIG. 12 as logic circuits to perform operations corresponding to those machine readable instructions. In some such examples, the circuitry of FIG. 12 is instantiated by the hardware circuits of the microprocessor 1500 in combination with the machine-readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowchart of FIG. 13.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Additionally or alternatively, the first bus 1504 may be implemented by any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data and/or instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages.

The microprocessor 1500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1500, in the same chip package as the microprocessor 1500 and/or in one or more separate packages from the microprocessor 1500.

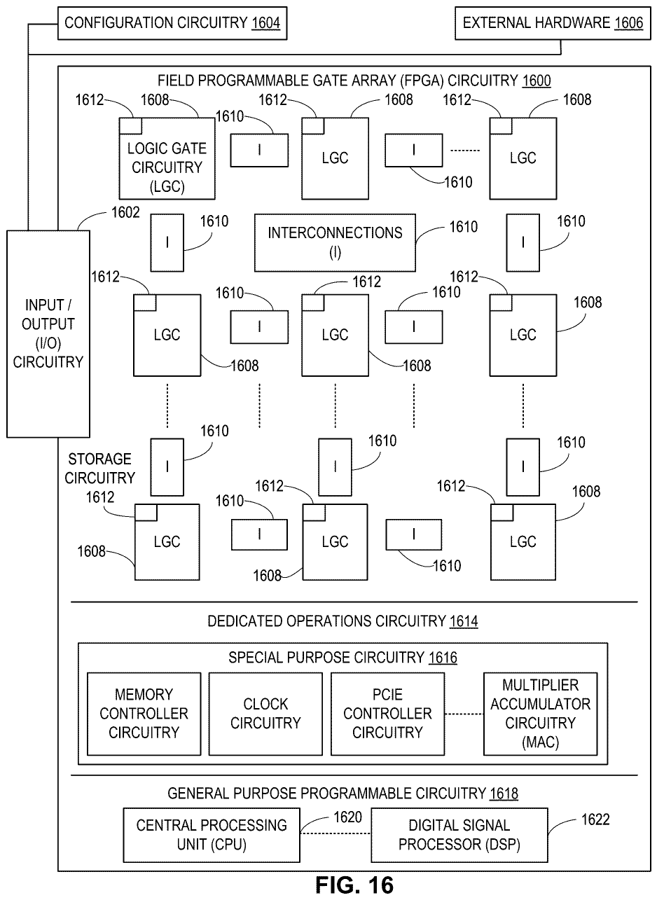

FIG. 16 is a block diagram of another example implementation of the programmable circuitry 1412 of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine readable instructions represented by the flowchart of FIG. 13 but whose interconnections and logic circuitry are fixed once fabricated), the FPGA circuitry 1600 of the example of FIG. 16 includes interconnections and logic circuitry that may be configured, structured, programmed, and/or interconnected in different ways after fabrication to instantiate, for example, some or all of the operations/functions corresponding to the machine readable instructions represented by the flowchart of FIG. 13. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 13. As such, the FPGA circuitry 1600 may be configured and/or structured to effectively instantiate some or all of the operations/functions corresponding to the machine readable instructions of the flowchart of FIG. 13 as dedicated logic circuits to perform the operations/functions corresponding to those software instructions in a dedicated manner analogous to an ASIC. Therefore, the FPGA circuitry 1600 may perform the operations/functions corresponding to the some or all of the machine readable instructions of FIG. 13 faster than the general-purpose microprocessor can execute the same.

In the example of FIG. 16, the FPGA circuitry 1600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain a binary file, which may be implemented by a bit stream, data, and/or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine readable instructions of FIG. 13 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the programmable circuitry 1412 of FIG. 14, many other approaches are contemplated. For example, FPGA circuitry may include an on-board CPU, such as one or more of the example CPU 1620 of FIG. 15. Therefore, the programmable circuitry 1412 of FIG. 14 may additionally be implemented by combining at least the example microprocessor 1500 of FIG. 15 and the example FPGA circuitry 1600 of FIG. 16. In some such hybrid examples, one or more cores 1502 of FIG. 15 may execute a first portion of the machine readable instructions represented by the flowchart of FIG. 13 to perform first operation(s)/function(s), the FPGA circuitry 1600 of FIG. 16 may be configured and/or structured to perform second operation(s)/function(s) corresponding to a second portion of the machine readable instructions represented by the flowchart of FIG. 13, and/or an ASIC may be configured and/or structured to perform third operation(s)/function(s) corresponding to a third portion of the machine readable instructions represented by the flowchart of FIG. 13.

It should be understood that some or all of the circuitry of FIG. 12 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be configured and/or structured to perform operations/functions corresponding to portion(s) of machine-readable instructions at the same and/or different times.

In some examples, some or all of the circuitry of FIG. 12 may be instantiated, for example, in one or more threads executing concurrently and/or in series. For example, the microprocessor 1500 of FIG. 15 may execute machine readable instructions in one or more threads executing concurrently and/or in series. In some examples, the FPGA circuitry 1600 of FIG. 16 may be configured and/or structured to carry out operations/functions concurrently and/or in series. Moreover, in some examples, some or all of the circuitry of FIG. 12 may be implemented within one or more virtual machines and/or containers executing on the microprocessor 1500 of FIG. 15.

In some examples, the programmable circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the programmable circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to enable navigation in the absence of available GNSS signals are disclosed herein. Further examples and combinations thereof include the following:
Example 1 includes an apparatus comprising interface circuitry communicatively coupled to an aiming device and an image sensor carried by an aircraft, machine-readable instructions, and at least one processor circuit to be programmed by the machine-readable instructions to determine orientations of the aiming device as the image sensor tracks a target via the aiming device, determine navigation information of the aircraft based on the orientations and flight sensor data corresponding to the tracking of the target with the image sensor, and guide movement of the aircraft based on the navigation information.
Example 2 includes the apparatus as defined in example 1, wherein one or more of the at least one processor circuit is to determine wind information based on the flight sensor data and the orientations, and wherein the movement is guided based on the wind information.
Example 3 includes the apparatus as defined in any of one or more of examples 1 or 2, wherein the flight sensor data includes at least one of inertial data or barometric data of the aircraft.
Example 4 includes the apparatus as defined in any of one or more of examples 1 to 3, wherein one or more of the at least one processor circuit is to determine a position of the aircraft relative to the target based on the flight sensor data and the orientations.
Example 5 includes the apparatus as defined in any of one or more of examples 1 to 4, wherein one or more of the at least one processor circuit is to cause the aircraft to orbit the target with the aiming device directing the image sensor toward the target.
Example 6 includes the apparatus as defined in any of one or more of examples 1 to 5, wherein the target is a ship, and one or more of the at least one processor circuit is to estimate a relative position of the aircraft to the ship and a wind condition with respect to a deck of the ship based on the flight sensor data and the orientations.
Example 7 includes the apparatus as defined in any of one or more of examples 1 to 6, wherein one or more of the at least one processor circuit is to guide movement of the aircraft toward the ship based on the relative position and the wind condition.
Example 8 includes at least one non-transitory machine-readable medium comprising machine-readable instructions to cause at least one processor circuit to at least determine orientations of an aiming device that orients an image sensor toward a target to track the target as an aircraft carrying the aiming device moves, and determine navigation information of the aircraft based on the orientations and flight sensor data corresponding to the tracking of the target with the image sensor.
Example 9 includes the at least one non-transitory machine-readable medium as defined in example 8, wherein the machine-readable instructions are to cause one or more of the at least one processor circuit to determine wind information based on the flight sensor data and the orientations, and control movement of the aircraft based on the wind information.
Example 10 includes the at least one non-transitory machine-readable medium as defined in any of one or more of examples 8 or 9, wherein the flight sensor data includes at least one of inertial data or barometric data of the aircraft.
Example 11 includes the at least one non-transitory machine-readable as defined in any of one or more of examples 8 to 10, wherein the machine-readable instructions are to cause one or more of the at least one processor circuit to determine a position of the aircraft relative to the target based on the flight sensor data and the orientations.
Example 12 includes the at least one non-transitory machine-readable medium as defined in any of one or more of examples 8 to 11, wherein the machine-readable instructions are to cause one or more of the at least one processor circuit to cause the aircraft to orbit the target with the aiming device directing the image sensor toward the target.
Example 13 includes the at least one non-transitory machine-readable medium as defined in any of one or more of examples 8 to 12, wherein the target is a ship, and wherein the machine-readable instructions are to cause one or more of the at least one processor circuit to estimate a relative position of the aircraft to the ship and a wind condition with respect to a deck of the ship based on the flight sensor data and the orientations.
Example 14 includes the at least one non-transitory machine-readable medium as defined in any of one or more of examples 8 to 13, wherein the machine-readable instructions are to cause one or more of the at least one processor circuit to guide movement of the aircraft toward a landing area of the ship based on the relative position and the wind condition.
Example 15 includes a method comprising determining, by at least one processor circuit programmed by at least one instruction, orientations of an aiming device that causes an image sensor to track a target as an aircraft carrying the aiming device moves relative to the target, determining, by one or more of the at least one processor circuit, navigation information of the aircraft based on the orientations and flight sensor data corresponding to the tracking of the target with the image sensor, and directing, by one or more of the at least one processor circuit, movement of the aircraft based on the navigation information.
Example 16 includes the method as defined in example 15, further including determining, by one or more of the at least one processor circuit, wind information based on the flight sensor data and the orientations, and wherein the movement is directed based on the wind information.
Example 17 includes the method as defined in any of one or more of examples 15 or 16, wherein the flight sensor data includes at least one of inertial data or barometric data of the aircraft.
Example 18 includes the method as defined in any of one or more of examples 15 to 17, further including causing, by one or more of the at least one processor circuit, the aircraft to orbit or maneuver relative to the target with the aiming device directing the image sensor toward the target.
Example 19 includes the method as defined in any of one or more of examples 15 to 18, further including determining, by one or more of the at least one processor circuit, (i) a relative position of the aircraft to a ship and (ii) a wind condition with respect to a deck of the ship based on the flight sensor data and the orientations.
Example 20 includes the method as defined in any of one or more of examples 15 to 19, wherein the movement of the aircraft is directed to cause the aircraft to land on the ship based on the relative position.
Example 21 includes the method as defined in any of one or more of examples 15 to 20, wherein the movement of the aircraft is directed based on the wind condition of the deck.

From the foregoing, it will be appreciated that example systems, apparatus, articles of manufacture, and methods have been disclosed that enable effective navigation in the absence of GNSS signals. Examples disclosed herein can also enable navigation with relatively little or no emissions and/or transmission of signals from vehicles, which can be highly advantageous in certain applications (e.g., reconnaissance, surveillance, etc.). Disclosed systems, apparatus, articles of manufacture, and methods improve the efficiency of using a computing device by utilizing readily available flight sensor information in conjunction with orientations of an aiming device and/or payload to estimate navigation information, which can be highly advantageous in lieu of existing systems that may necessitate computationally intensive calculations and/or specialized modelling for navigation in the absence of GNSS information. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry communicatively coupled to an aiming device and an image sensor carried by an aircraft;
machine-readable instructions; and
at least one processor circuit to be programmed by the machine-readable instructions to:
determine orientations of the aiming device as the image sensor tracks a target via the aiming device;
determine navigation information of the aircraft based on the orientations and flight sensor data corresponding to the tracking of the target with the image sensor; and
guide movement of the aircraft based on the navigation information.

2. The apparatus as defined in claim 1, wherein one or more of the at least one processor circuit is to determine wind information based on the flight sensor data and the orientations, and wherein the movement is guided based on the wind information.

3. The apparatus as defined in claim 1, wherein the flight sensor data includes at least one of inertial data or barometric data of the aircraft.

4. The apparatus as defined in claim 1, wherein one or more of the at least one processor circuit is to determine a position of the aircraft relative to the target based on the flight sensor data and the orientations.

5. The apparatus as defined in claim 4, wherein one or more of the at least one processor circuit is to cause the aircraft to orbit the target with the aiming device directing the image sensor toward the target.

6. The apparatus as defined in claim 1, wherein the target is a ship, and one or more of the at least one processor circuit is to estimate a relative position of the aircraft to the ship and a wind condition with respect to a deck of the ship based on the flight sensor data and the orientations.

7. The apparatus as defined in claim 6, wherein one or more of the at least one processor circuit is to guide movement of the aircraft toward the ship based on the relative position and the wind condition.

8. At least one non-transitory machine-readable medium comprising machine-readable instructions to cause at least one processor circuit to at least:
determine orientations of an aiming device that orients an image sensor toward a target to track the target as an aircraft carrying the aiming device moves; and
determine navigation information of the aircraft based on the orientations and flight sensor data corresponding to the tracking of the target with the image sensor.

9. The at least one non-transitory machine-readable medium as defined in claim 8, wherein the machine-readable instructions are to cause one or more of the at least one processor circuit to:
determine wind information based on the flight sensor data and the orientations, and
control movement of the aircraft based on the wind information.

10. The at least one non-transitory machine-readable medium as defined in claim 8, wherein the flight sensor data includes at least one of inertial data or barometric data of the aircraft.

11. The at least one non-transitory machine-readable medium as defined in claim 8, wherein the machine-readable instructions are to cause one or more of the at least one processor circuit to determine a position of the aircraft relative to the target based on the flight sensor data and the orientations.

12. The at least one non-transitory machine-readable medium as defined in claim 11, wherein the machine-readable instructions are to cause one or more of the at least one processor circuit to cause the aircraft to orbit the target with the aiming device directing the image sensor toward the target.

13. The at least one non-transitory machine-readable medium as defined in claim 8, wherein the target is a ship, and wherein the machine-readable instructions are to cause one or more of the at least one processor circuit to estimate a relative position of the aircraft to the ship and a wind condition with respect to a deck of the ship based on the flight sensor data and the orientations.

14. The at least one non-transitory machine-readable medium as defined in claim 13, wherein the machine-readable instructions are to cause one or more of the at least one processor circuit to guide movement of the aircraft toward a landing area of the ship based on the relative position and the wind condition.

15. A method comprising:
determining, by at least one processor circuit programmed by at least one instruction, orientations of an aiming device that causes an image sensor to track a target as an aircraft carrying the aiming device moves relative to the target;
determining, by one or more of the at least one processor circuit, navigation information of the aircraft based on the orientations and flight sensor data corresponding to the tracking of the target with the image sensor; and
directing, by one or more of the at least one processor circuit, movement of the aircraft based on the navigation information.

16. The method as defined in claim 15, further including determining, by one or more of the at least one processor circuit, wind information based on the flight sensor data and the orientations, and wherein the movement is directed based on the wind information.

17. The method as defined in claim 15, wherein the flight sensor data includes at least one of inertial data or barometric data of the aircraft.

18. The method as defined in claim 15, further including causing, by one or more of the at least one processor circuit, the aircraft to orbit or maneuver relative to the target with the aiming device directing the image sensor toward the target.

19. The method as defined in claim 15, further including determining, by one or more of the at least one processor circuit, (i) a relative position of the aircraft to a ship and (ii) a wind condition with respect to a deck of the ship based on the flight sensor data and the orientations.

20. The method as defined in claim 19, wherein the movement of the aircraft is directed to cause the aircraft to land on the ship based on the relative position.

21. The method as defined in claim 20, wherein the movement of the aircraft is further directed based on the wind condition of the deck.
